(19) United States
(12) Patent Application Publication
(10) Pub. No.: US 2017/0357610 A1
(43) Pub. Date: Dec. 14, 2017

(54) SPLIT NVME SSD IMPLEMENTATION USING NVME OVER FABRICS PROTOCOL

(71) Applicant: Kazan Networks Corporation, Loomis, CA (US)

(72) Inventor: Michael Ivan Thompson, Colfax, CA (US)

(73) Assignee: Kazan Networks Corporation, Loomis, CA (US)

(21) Appl. No.: 15/623,194

(22) Filed: Jun. 14, 2017

Related U.S. Application Data
(60) Provisional application No. 62/349,829, filed on Jun. 14, 2016.

(51) Int. Cl. G06F 13/42; G06F 13/40; G06F 12/02

(52) U.S. Cl. CPC G06F 13/4282; G06F 12/0246; G06F 13/4081; G06F 2213/0026; G06F 2212/7201

(57) ABSTRACT

One implementation of an NVMe storage system uses NVMe over Fabric (NVMf) SSDs. This implementation is built using off-the-shelf RDMA Network Interface Cards (RNIC) to connect the server to the network and then to the NVMf SSDs. The current document discloses a split implementation with the PCI Express/NVMe interface on an NVMe Initiator board plugged into a server and the Flash implemented on one or many network attached Flash (NVMf) devices.

### CROSS-REFERENCE TO RELATED APPLICATION

This application claims the benefit of Provisional Application No. 62/349,829, filed Jun. 14, 2016.

### TECHNICAL FIELD

The current document is directed to hardware controllers and, in particular, to an integrated hardware controller and peripheral component interconnect serial bus that interconnects a non-volatile-memory-express (“NVMe”) solid-state disk (“SSDs”) to a local area network and, ultimately, to remote server computers.

### BACKGROUND

As computer technologies have advanced over the past 20 years, large, distributed cloud-computing facilities and other large, distributed-computing systems have begun to dominate provision of computational bandwidth and data storage to business organizations. As the price performance, bandwidths, and storage capacities of computer-system components have rapidly increased, computational services are now provided to organizations and individuals by cloud-computing facilities in a fashion similar to provision of electrical energy and water to consumers by utility companies. As a result of rapid growth in the cloud-computing industry, the demand for computational bandwidth, data storage, and networking bandwidth has dramatically increased, providing great incentives to cloud-computing providers to increase the economic efficiency of cloud-computing facilities and other large distributed-computing systems.

The rapid decrease in the cost of storing data and hard disk drives during the latter half of the 1990s helped to spur the development of cloud computing and big-data applications. More recently, the development of solid-state disks (“SSDs”) and rapid increase in price performance of SSDs has provided an approach to more efficient and robust data storage. Designers and developers of distributed-computer systems, cloud-computing-facility owners and managers, and, ultimately, consumers of computational bandwidth and data storage continue to seek technologies for incorporating large numbers of high-capacity SSDs into cloud-computing facilities and distributed-computer systems.

### SUMMARY

One implementation of an NVMe storage system uses NVMe over Fabric (NVMf) SSDs. This implementation is built using off-the-shelf RDMA Network Interface Cards (RNIC) to connect the server to the network and then to the NVMf SSDs. The current document discloses a split implementation with the PCI Express/NVMe interface on an NVMe Initiator board plugged into a server and the Flash implemented on one or many network attached Flash (NVMf) devices.

### BRIEF DESCRIPTION OF THE DRAWINGS

FIG. 1 illustrates a current NVMf implementation.

FIG. 2 illustrates a split NVMe implementation.

### DETAILED DESCRIPTION

A normal NVMe SSD implementation would have a PCI Express-based Flash controller and a given amount of Flash mounted on a board that is plugged into a server chassis. This limits the amount of Flash memory that can provided by the size of the PCI Express board form factor. It also limits the accessibility to the Flash to the server that the NVMe card is physically plugged into.

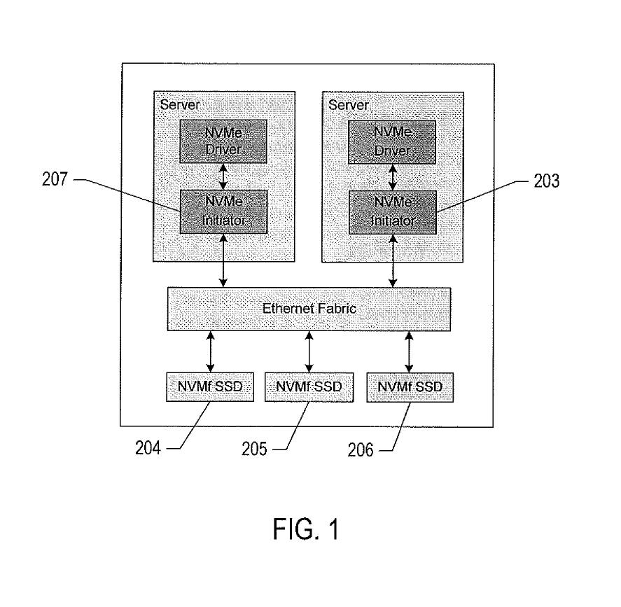

Another implementation of an NVMe storage system uses NVMe over Fabric (NVMf) SSDs, shown FIG. 1. This implementation would be built using off-the-shelf RDMA Network Interface Cards (RNIC) 102 to connect the server to the network 104 and then to the NVMf SSDs 106. This solution requires the addition of a new driver 108 that is inserted between the NVMe Driver 110 and the RNIC 102 to do the conversion between the standard NVMe protocol and the interface to the RNIC. This solution is disruptive to the server, adds latency to the server's storage system, and adds the cost of a general purpose RNIC.

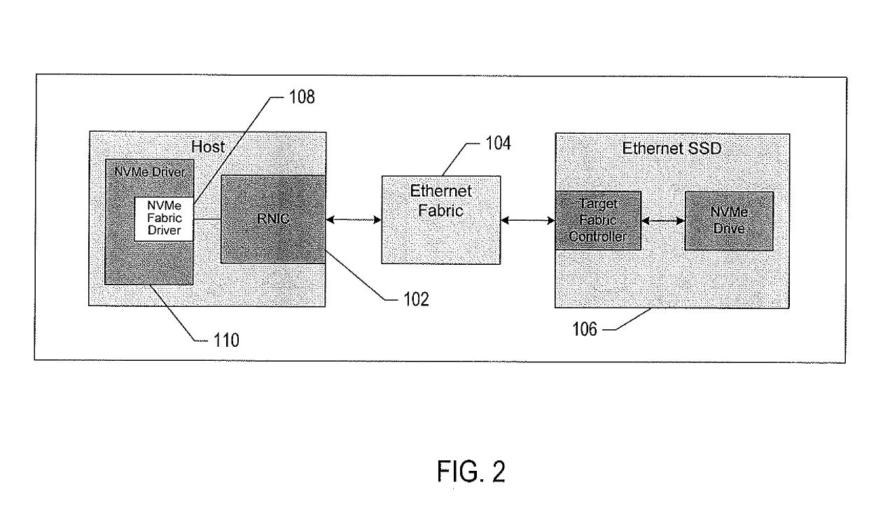

In the configuration described here, shown in FIG. 2, the implementation is split with the PCI Express/NVMe interface on an NVMe Initiator board plugged into a server and the Flash implemented on one or many network attached Flash (NVMf) devices. Both the NVMe Initiator card 202-203 and the network attached Flash devices 204-206 use the NVMe over Fabrics protocol to connect them together. This split implementation allows for virtually unlimited growth in the size of the SSD presented to the server system and also allows many server systems to access the same network attached Flash devices. Further, the purpose built NVMe Initiator is designed to reduce latency and cost by focusing on features needed for the NVMe system as opposed to the feature set required of a general purpose RNIC.

The NVMf SSD is a Solid State Disk that provides non-volatile data storage. This device can be implemented using any form of non-volatile storage, including rotating media hard drives, with the single requirement that it presents an NVMe over Fabrics compatible interface to the Ethernet network.

The NVMe Initiator is a PCI Express plug-in card that appears to the server system as a complete implementation of an NVMe SSD, but in fact only includes an NVMe interface and an NVMe over Fabrics interface. It does not include the actual non-volatile memory.

1. A Split NVMe implementation comprising:
a PCI Express/NVMe interface on an NVMe Initiator board plugged into a server, and
a Flash implemented on a network-attached NVMf device;
wherein the NVMe initiator interface and the network-attached NVMf device are connected via an NVMe-over-Fabrics protocol.
